(19) United States
(12) Patent Application Publication
(10) Pub. No.: US 2011/0000745 A1
(43) Pub. Date: Jan. 6, 2011

(54) MOTORCYCLE LIFT FOR CAR WASH

(76) Inventor: Richard Good, Mohnton, PA (US)

Correspondence Address: VOLPE AND KOENIG, P.C., UNITED PLAZA, 30 SOUTH 17TH STREET, PHILADELPHIA, PA, 19103, US

(21) Appl. No.: 12/792,870

(22) Filed: Jun. 3, 2010

Related U.S. Application Data
(60) Provisional application No. 61/222,215, filed on Jul. 1, 2009.

(51) Int. Cl. B66F 7/16; B66F 7/10; B66F 7/20; B66F 7/28

(52) U.S. Cl. 187/215; 187/210

(57) ABSTRACT

A motorcycle lift for a wash service bay which is specifically adapted for cleaning motorcycles is provided. The lift includes a lift bed having guide rails and supports for holding a motorcycle on the lift bed. At least one actuator is provided connected to the lift bed and are recessed in a well below the ground level of the wash service bay so that the motorcycle can be moved along the ground level onto the lift bed, where it is then secured in position. Preferably, there are a plurality of actuators that are staged cylinders connected in series for coordinated lifting of the lift bed to raise the motorcycle to an elevated position, to allow easier access for washing and waxing or other cleaning. The actuators are connected to a controller for controlled raising and lowering of the lift bed between a first, ground level position, for loading and unloading the motorcycle, and a second, raised level which provides easier access for cleaning.

### CROSS-SECTION TO RELATED APPLICATIONS

This application claims the benefit of U.S. Provisional Application No. 61/222,215, filed Jul. 1, 2009, which is incorporated herein by reference as if fully set forth.

### BACKGROUND

The invention relates to a motorcycle lift for use in a car wash.

Car washes are known for automobiles in which the automobile is driven inside a wash service bay and implements for washing and waxing the automobile are readily available. These systems generally operate using a pre-paid card, token or other type of controlled or timed service which allows the user to then wash the automobile, apply hot wax, clean the tires and rims, and in some instances dry the vehicle using blown air prior to leaving the wash service bay. While it is possible to pull a motorcycle into these existing automobile wash bays in order to perform similar cleaning and waxing, it is often inconvenient for a user to work on the motorcycle as it sits low to the ground and it would be more convenient to provide for easier access.

### SUMMARY

A motorcycle lift for a wash service bay which is specifically adapted for cleaning motorcycles is provided. The lift includes a lift bed having guide rails and support posts specifically provided for holding a motorcycle upright and in a secure position on the lift bed. At least one actuator is provided connected to the lift bed and is located in a well below the ground level of the wash service bay so that the motorcycle can be moved along the ground level onto the lift bed, where it is then secured in position. Preferably, there are a plurality actuators which comprise staged cylinders connected in series for coordinated lifting of the lift bed to raise the motorcycle to an elevated position, preferably to allow easier access for washing and waxing or other cleaning. The actuators are located in the well and protected via an outer actuator cover tube which telescopically glides over an inner actuator cover tube to prevent cleaning fluids from getting into the actuators. The actuators are connected to a controller for controlled raising and lowering of the lift bed between a first, ground level position, for loading and unloading the motorcycle, and a second, raised level which provides easier access for cleaning.

### BRIEF DESCRIPTION OF THE DRAWING(S)

The foregoing Summary and the following detailed description will be better understood when read in conjunction with the following drawings, which illustrate preferred embodiments of the invention. In the drawings:

FIG. 1 is a schematic view showing the motorcycle lift system in accordance with the present invention.

FIG. 2 is a cross-section view through the lift at one of the actuator locations.

FIG. 3 is a perspective view showing the lift in the lowered position, with the grate and side skirt removed for clarity.

FIG. 4 is a perspective view similar to FIG. 3 showing the lift in a raised position.

FIG. 5 is a view of the lift similar to FIG. 3 shown with the grates and side skirt in position.

FIG. 6 is a view similar to FIG. 5 showing a front tire of a motorcycle in the forward position held in a front fork and on the rocker plate.

FIG. 7 is an enlarged side view showing the front holding implements for the motorcycle front wheel.

FIG. 8 is a top view of the front V bracket.

FIG. 9 is a rear view of the rocker plate assembly.

FIG. 10 is a cross-sectional view through a portion of the lift bed and the side skirt showing the arrangement of the lift bed frame, grate and side skirt.

### DETAILED DESCRIPTION OF THE PREFERRED EMBODIMENT(S)

Certain terminology is used in the following description for convenience only and is not considered limiting. Words such as “front,” “back,” “top,” and “bottom” designate directions in the drawings to which reference is made. This terminology includes the words specifically noted above, derivatives thereof, and words of similar import. Additionally, the terms “a” and “one” are defined as including one or more of the referenced item unless specifically noted.

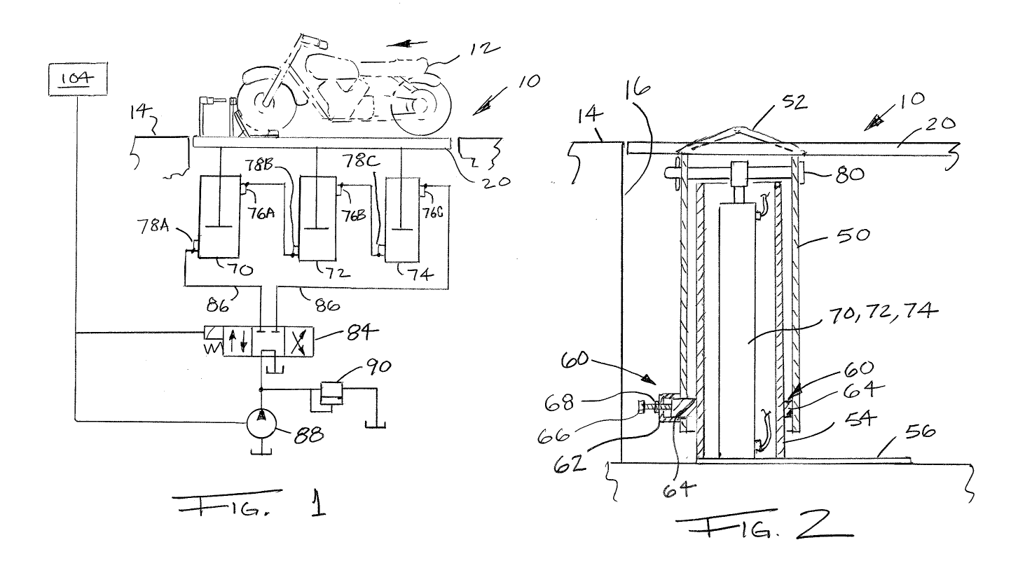

Referring to FIG. 1, the motorcycle lift 10 for a wash service bay is shown in schematic form with a motorcycle 12 on the lift bed 20. The lift bed 20 is shown in the lowered, loading and unloading position even with ground level 14.

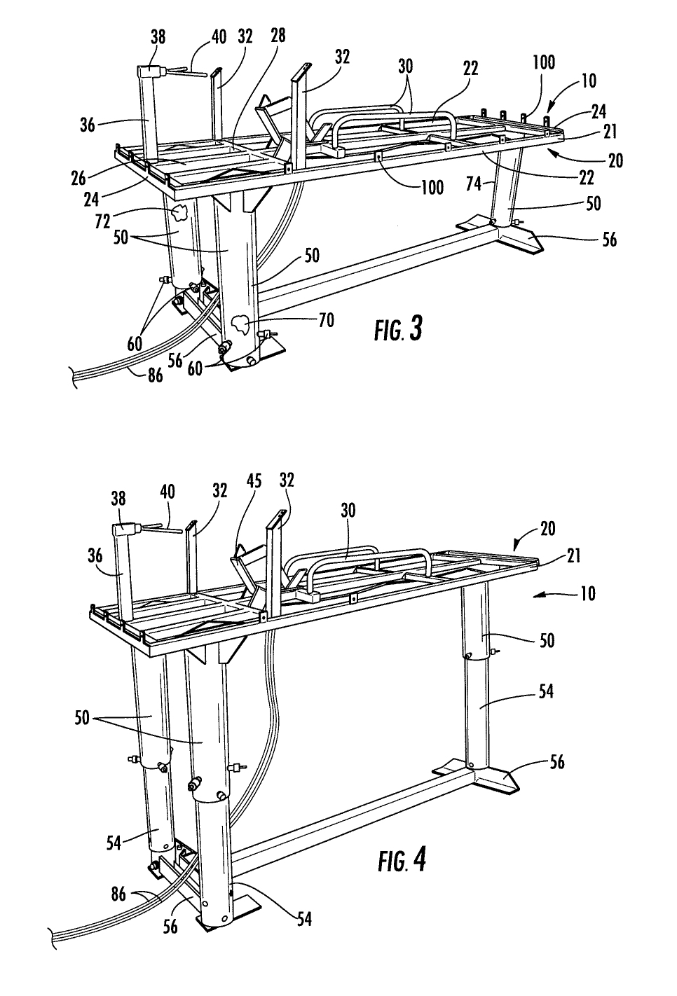

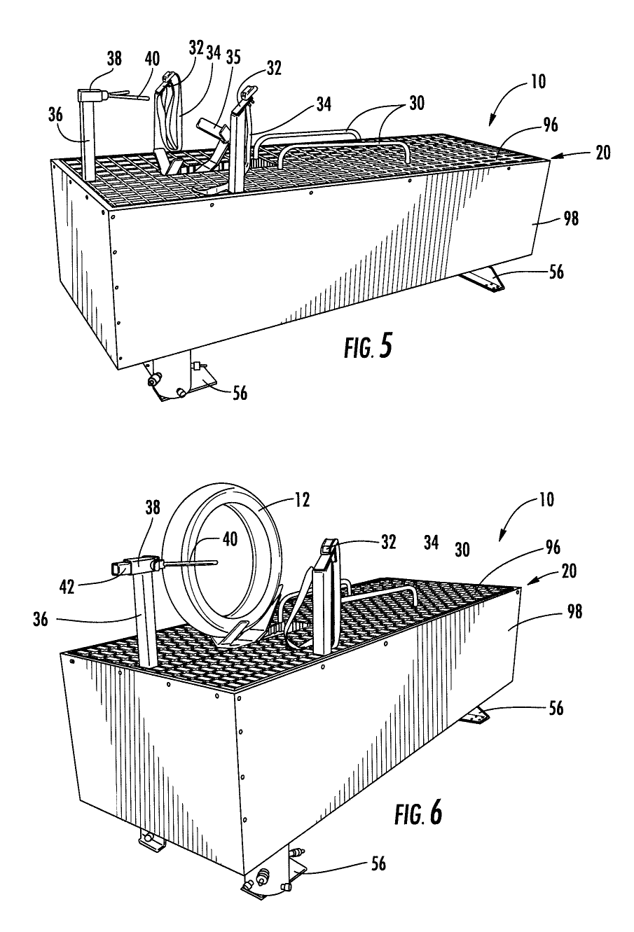

Referring to FIGS. 2-6, the lift bed 20, best shown in FIGS. 3 and 4, is comprised of a frame 21 with outer rails 22 and outer cross members 24 which are formed of box beams and are connected together, preferably via welding. Inner rails 26 and inner cross members 28 are also provided in order to support a grate 96 as shown in FIGS. 5 and 6. While a specific configuration of the lift bed frame 21 is shown, those skilled in the art will recognize that various other configurations could be provided as all that is required is a stable platform for supporting the motorcycle as it is being lifted.

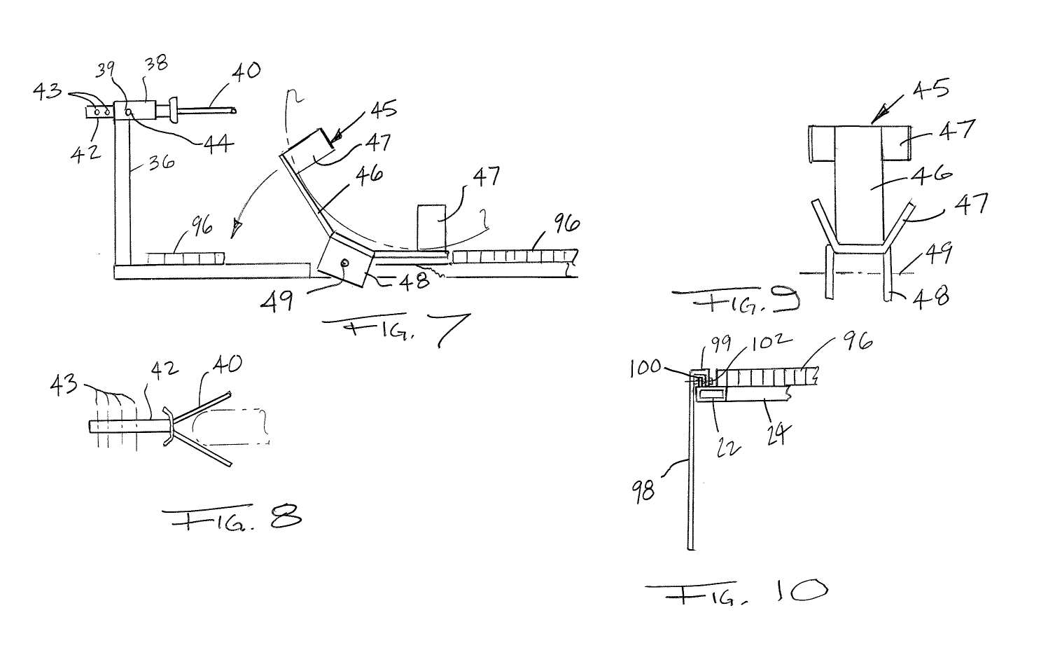

In order to hold the motorcycle on the lift bed 20, hold down posts 32 are provided at either side toward the front of the lift bed 20. Hold down straps 34 are connected to the hold down posts 32 and can be used to secure a motorcycle in position. Guide rails 30, best shown in FIGS. 3-6, are used to guide the front wheel of the motorcycle 12 toward a wheel engaging rocker assembly 45, explained in detail below, and a front post 36 having a sleeve 38 connected to the top thereof for supporting a V-bracket 40. The V-bracket 40 is shown in detail in FIGS. 7 and 8, and includes a tube member 42 having a plurality of holes 43 extending therethrough, with the V-shaped member 41 connected to one end. The tube 42 is slidable in the sleeve 38, and one of the holes 43 can be aligned with a hole 39 in the sleeve 38. A pin 44 is placed through the aligned holes to lock the V-bracket 40 in position. This arrangement allows for adjustment forward and backward for the V-shaped member 41 to engage tires of various size.

The rocker assembly 45 is shown in detail in FIGS. 7 and 9 and includes a bent-up base 46 having support wings 47 located at both ends thereof. The support wings 47 are in a generally U-shaped configuration as shown in FIG. 9. Pivot wings 48 extend downwardly from a center section of the base 46. The rocker assembly 45 is connected about a pivot axis 49 to the lift bed 20, preferably with a pin connection.

Referring to FIGS. 1 and 3, the lift bed 20 is supported via three actuators 70, 72, 74 that are each located within respective outer actuator cover tubes 50 that are connected to the underside of the lift bed frame 21. A preferred arrangement is shown in FIGS. 3 and 4. However, other arrangements of the actuators are possible. The actuators 70, 72, 74 are protected from water and other materials used in washing the motorcycle by a cap 52 that covers the opening of the outer tube 50. An inner actuator cover tube 54 is located telescopically within the outer actuator cover tube 50, as shown in FIG. 2. The bottoms of the inner actuator cover tubes 54 are connected to a support base 56, which is preferably as shown in FIGS. 3 and 4 and made of welded steel plates and box beams in order to hold the bottoms of the inner cover tubes 54 in a fixed position.

In order to maintain the concentric alignment of the outer tubes 50 with the inner tubes 54, preferably slide assembly 60 are spaced equally about the circumference of each of the outer tubes 50. As shown in FIG. 3, preferably three slide assemblies 60 are provided on each outer tube 50 spaced apart by 120°. The slide assemblies 60 include a hollow cap 62 having a threaded opening 63. A nylon block 64 is slidably arranged within the hollow cap 62 and can be pressed inwardly toward the outer surface of the inner tube 54 by a bolt 66 engaged in the threaded opening 63. A lock nut 68 is used to lock the bolt 66 in position after the position of the nylon slide block 64 has been set.

Still with reference to FIG. 2, the respective actuators 70, 72, 74 are located within the cover tubes 50, 54 and can either be pinned or affixed at the bottom of the inner tube 54 or onto the support base 56 at one end and are preferably connected via a pin 80 at the upper end to the outer cover tube 50 or to the bottom of the lift bed 20.

As shown in FIG. 1, where the hydraulic circuit is schematically illustrated, the actuators 70, 72, 74 are staged actuators with the first actuator 70 preferably having an outer cylinder size of 2½ inches in diameter and an inner piston size of 1⅛ inch in diameter. The second actuator has an inner cylinder size of 2¼ inches and an inner piston of 1 inch in diameter, and the third actuator has an outer cylinder size of 2 inches and an inner piston of 1 inch. These actuators 70, 72, 74 are connected in series via hydraulic tubing 86. Each of the actuators 70, 72, 74 includes a top rephasing port 76a, 76b, 76c and a bottom rephasing port 78a, 78b, 78c. The rephasing ports preferably have an opening size of between 0.040 and 0.050 of an inch in diameter in order to allow equalization between the hydraulic cylinders 70, 72, 74 to occur after the top and bottom positions have been reached. The bottom rephrasing ports 78a, 78b, 78c also preferably each include a check valve to prevent loss of fluid during the initial lift phase. The check valves are open to allow fluid flow as the actuators 70, 72, 74 are going down, but prevent flow through the rephrasing ports 78a, 78b, 78c as the actuators 70, 72, 74 are being raised.

Preferably, a solenoid valve 84 is provided in order to control the flow of hydraulic fluid from the pump 88 in order to either raise all three actuators 70, 72, 74; lower all three actuators 70, 72, 74; or to hold the actuators in a hydraulically locked position by not allowing the flow or hydraulic fluid into or out of the actuators 70, 72, 74 or hydraulic lines 86. As shown in FIG. 1, preferably a pressure relief valve 90 is also connected in line with the pump 88.

Still with reference to FIG. 1, a controller 104 is provided for controlling the solenoid valve 84 and the motor (not shown) for the hydraulic pump 88. In a preferred embodiment, the controller 104 is set to stop the motor for the pump 88 prior to de-energizing the solenoid valve 84 in order to allow pressure to be relieved in the hydraulic lines 86. In the preferred embodiment, the delay time between shutting off the motor for the pump 88 and shutting off the power to the solenoid valve 84 so it returns to the position shown in FIG. 1 is 0.5 seconds to 1 second. This prevents sagging or jumping of the lift bed 20 from occurring when it reaches the raised or lowered position, respectively.

Referring to FIGS. 5, 6 and 10, a grate 96 is preferably located on the lift bed frame 21. In the preferred embodiment, the grate 96 is installed in separate sections around the posts 32 and 36 as well as the guide rails 30 which guide the front wheel of the motor cycle into the proper position for holding. The grate 96 is preferably made of fiberglass in order to prevent corrosion or decay.

Still with references to FIGS. 5, 6 and 10, a skirt 98 is located around the periphery of the lift bed 20 in order to protect a user from the moving components during use. With the lift 10 installed in a well 16, the skirt 98 covers the exposed sides of the lift mechanism in the raised position. Preferably, the skirt 98 is formed of stainless steel sheet and includes an upper rim 99 having a J-shape which engages over connector tabs 100 (shown best in FIG. 3) located around the periphery of the lift bed frame 21. Fasteners 102 can be installed through corresponding openings in the inner edge of the J-shaped rim 99 in order to hold the skirt 98 in position. The outer rails 22 and cross members 24 are wide enough to provide a support inside of the rim 99 for the outer peripheral edge of the grate 96. The inner rails 26 and cross members 28 are spaced apart such that the internal edges of the separate pieces used to make up the grate 96 covering the entire upper surface of the lift bed 20 are fully supported.

In the preferred embodiment the controller 104 is integrated with the controls for a car wash. However, it can be a separate controller for controlling only the lift functions separate and apart from the motorcycle cleaning functions.

In use, the lift 10 is installed in a well 16 located below ground level 14 so that the upper surface of the lift bed (or the grate 96 located thereon) is generally level with the surface of the ground 14. A user can then drive or push their motorcycle onto the lift bed with the front wheel being guided via the guiderails 30 into the rocker assembly 45 which rocks forward to the position shown in FIGS. 5 and 6 with the front wheel of the motorcycle located thereon in an over center position, guiding the front wheel into the V-bracket 40. The straps 34 on top of the hold down posts 32 are then utilized to strap the motorcycle 12 into position. Once positioned on the lift 10, the hydraulic circuit is actuated with the solenoid valve 84 being shifted to the lifting position and the hydraulic pump 88 being turned on. Hydraulic fluid is sequentially pumped through the staged actuator cylinders 70, 72, 74 which lift the lift bed 20 to the raised position, shown in FIG. 4. Preferably, the raised position is approximately 24 to 30 inches above ground level in order to allow a user easy access to the side and bottom of the motorcycle frame for easy cleaning. Once the cleaning operations are completed, the solenoid valve 84 is moved to the lowering position and fluid is driven in the reverse direction through the hydraulic tubes 86 in order power the lift bed 20 to the lowered position where the motorcycle 12 can then be removed from the lift 10.

Preferably, the frame is made from welded steel and is protected with a corrosion resistant finish. Alternatively, it can be made from stainless steel or other suitable corrosion resistant materials. The posts 32 and 36 can be welded to the lift bed frame 21, or can be removably engaged in appropriately sized sockets, so that they can be removed, so that the motorcycle lift 10 can be installed in a wash service bay that is suitable for both motorcycles and automobiles.

While a preferred embodiment of the invention has been described in detail, the invention is not limited to the preferred construction noted above. Other arrangements of the actuators can be utilized, including a single actuator with a scissor jack arrangement in order to raise and lower the lift bed. The scope of the invention should be assessed in view of the appended claims.

What is claimed is:

1. A motorcycle lift for a wash service bay, comprising:
a lift bed having guide rails and supports for holding a motorcycle on the lift bed;
at least one actuator connected to the lift bed and are adapted to be located in a well below ground level of the wash service bay so that the motorcycle can be moved along the ground level onto the lift bed;
a holder that engages a front wheel of the motorcycle connected to the lift bed;
a hydraulic pump and a control valve connected to a hydraulic circuit for actuating the at least one actuator for controlled raising and lowering of the lift bed between a first, ground level position, for loading and unloading the motorcycle, and a second, raised level which provides easier access for cleaning; and
a controller for controlling the hydraulic pump and the control valve.

2. The motorcycle lift of claim 1, wherein there are a plurality of the actuators, which comprise staged cylinders connected in series for coordinated lifting of the lift.

3. The motorcycle lift of claim 2, wherein each of the actuators includes an upper rephrasing port and a lower rephrasing port.

4. The motorcycle lift of claim 3, wherein the rephrasing ports have a diameter of about 0.040 to 0.050 inches.

5. The motorcycle lift of claim 2, wherein each of the actuators is located within an outer actuator cover tube and an inner actuator cover tube that is concentrically arranged within the outer actuator cover tube, and slide assemblies are arranged on the outer actuator cover tubes that contact the inner actuator cover tube to maintain an alignment of the tubes.

6. The motorcycle lift of claim 1, wherein the holder comprises a rocker assembly pivotally attached to the lift bed, the rocker assembly includes a bent-up base with support wings located at each end.

7. The motorcycle lift of claim 1, further comprising hold-down posts extending up on either side of the lift bed, and a hold down strap connected to at least one of the hold down posts.

8. The motorcycle lift of claim 7, further comprising a front post connected to the lift bed in a generally centered location, and a V-bracket connected to the front post.

9. The motorcycle lift of claim 8, wherein the V-bracket is adjustable in a direction perpendicular to the front post.

10. The motorcycle lift of claim 1, wherein the controller is adapted to stop a motor for the hydraulic pump prior to de-energizing the solenoid valve in order to allow pressure to be relieved in hydraulic lines connected between the hydraulic pump and the at least one actuator.

11. The motorcycle lift of claim 1, further comprising a fiberglass grate located on the lift bed.
